(19) United States
(12) Patent Application Publication
(10) Pub. No.: US 2004/0041667 A1
(43) Pub. Date: Mar. 4, 2004

(54) Multi-polar cascade quadruplet band pass filter based on dielectric dual mode resonators

(76) Inventors: Huai-ren Yi, Mount Prospect, IL (US); Norbert Klein, Monchengladbach (DE)

Correspondence Address: DOWELL & DOWELL PC, SUITE 309, 1215 JEFFERSON DAVIS HIGHWAY, ARLINGTON, VA, 22202

(21) Appl. No.: 10/332,671

(22) PCT Filed: Jun. 27, 2001
(86) PCT No.: PCT/DE01/02382

(30) Foreign Application Priority Data
Jul. 14, 2000 (DE) 10034338.4

(51) Int. Cl. H01P 1/20

(52) U.S. Cl. 333/202

(57) ABSTRACT

The invention relates to a multi-polar band pass filter based on a group of dielectric mode resonators which are placed in a metal housing and coupled to each other. The dual metal housing comprises metal walls. Said metal walls effect a coupling between the dual mode resonators in such a way that one positive forward coupling between the respective neighboring pairs of resonators and a positive and a negative coupling within each pair of resonators arises.

The present invention relates to a multi-polar bandpass filter based on a group of dielectric dual mode resonators which are arranged in a metal housing and coupled to one another.

From the prior art, dielectric dual mode resonators are known which can e.g. be used in communication satellites for channel separation. It is difficult to couple dual mode resonators without greatly affecting the quality. An axial arrangement of cylindrical dielectric dual mode resonators is known in which individual resonator chambers are coupled by cruciform diaphragms. In this case, relatively elevated high-frequency currents flow in the area of the diaphragms which greatly affect the attainable filtering qualities (U.S. Pat. No. 4,489,293). In an earlier patent application, we merely used a four-polar bandpass filter formed by coupling two dual mode resonators (DE 19824997, pending).

Thus, the object of the present invention is to create a design for a multi-polar bandpass filter with which it is possible to couple as many dual mode resonator pairs (quadruplets) as desired while at the same time maintaining high filtering quality.

According to the invention, the object is solved thereby that metal walls in the metal housing produce the coupling between the dual mode resonators in such a way that, on the one hand, a positive forward coupling takes place between respectively adjacent resonator pairs and, on the other hand, a positive and a negative coupling takes place within each pair of resonators.

With a cascade quadruplet filter of this type, pairs of finite zero lines of transmission can be obtained which are arranged largely symmetrically about the centre of the bandpass.

Further advantages of the present invention can be found in the features of the subclaims 2 to 9.

Embodiments of the present invention are described in greater detail in the following with reference to the drawings, showing:

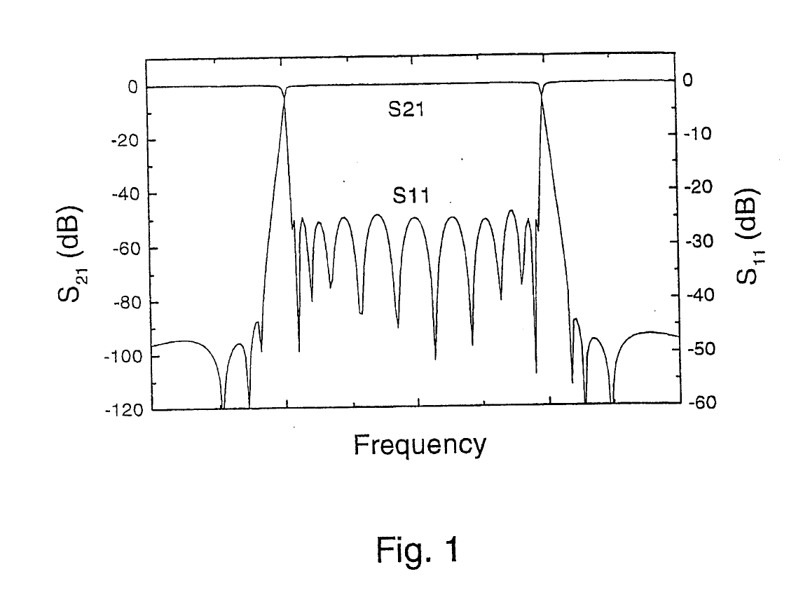

FIG. 1 a typical characteristic curve of a twelve-polar, cascade quadruplet filter;

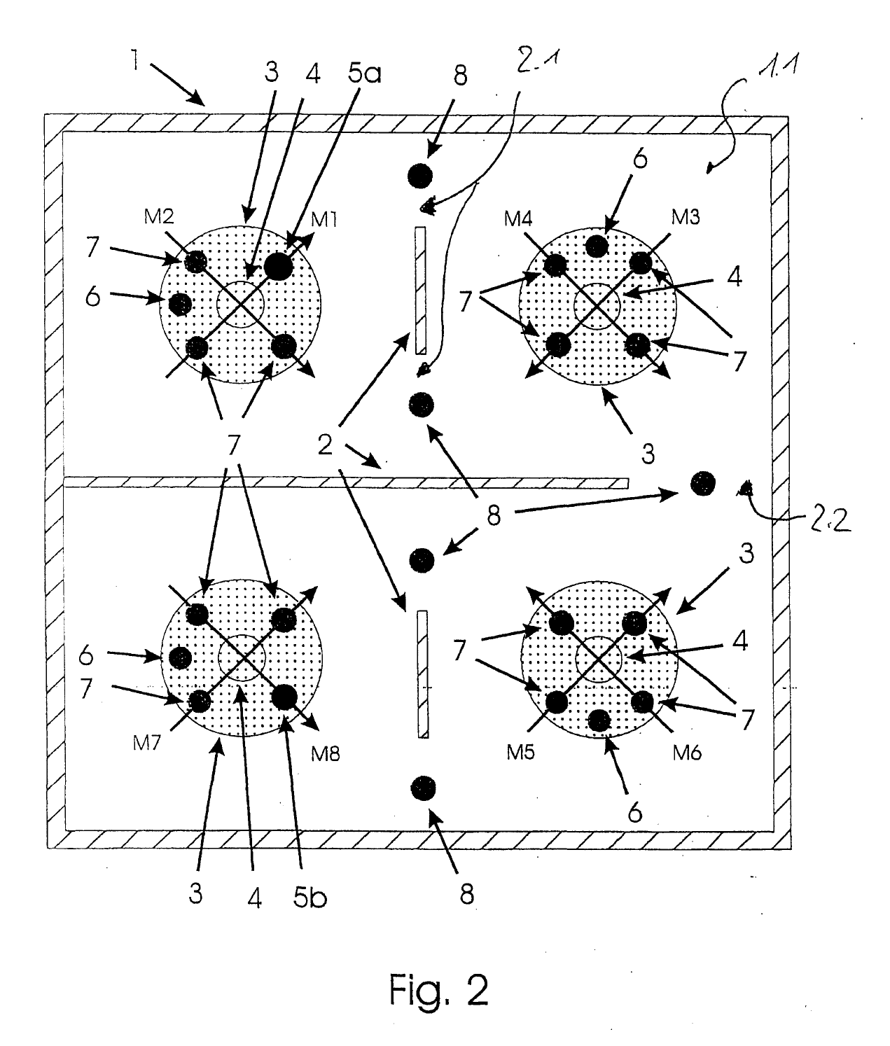

FIG. 2 a schematic top view onto an eight-polar filter having four dielectric dual mode resonators;

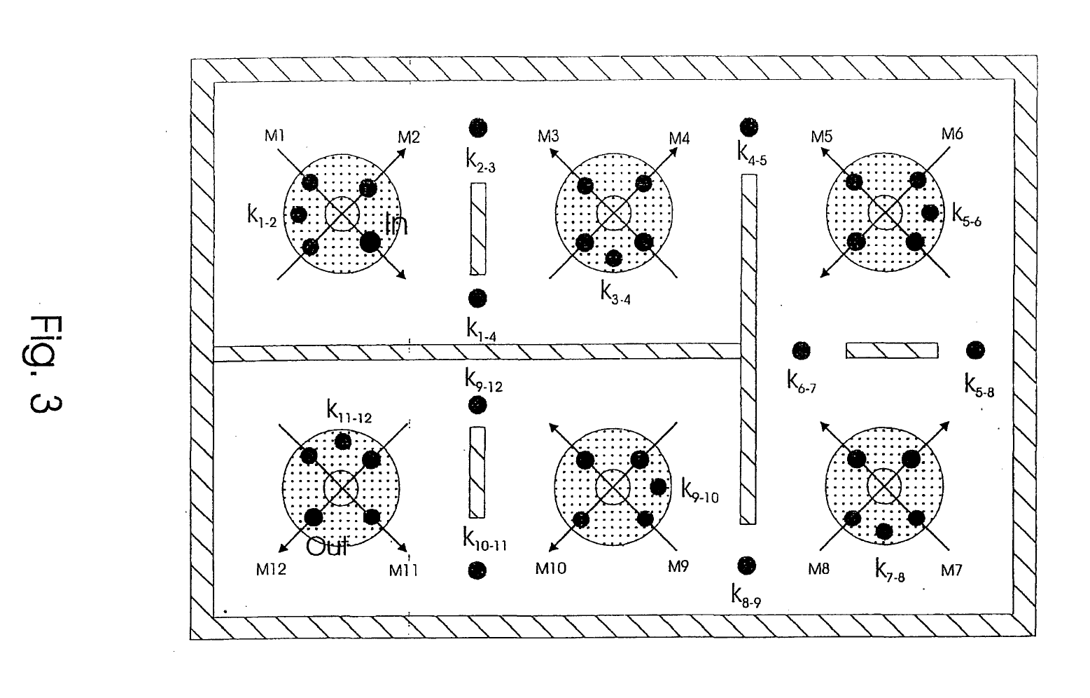

FIG. 3 a schematic top view onto a twelve-polar cascade quadruplet filter having six dielectric dual mode resonators;

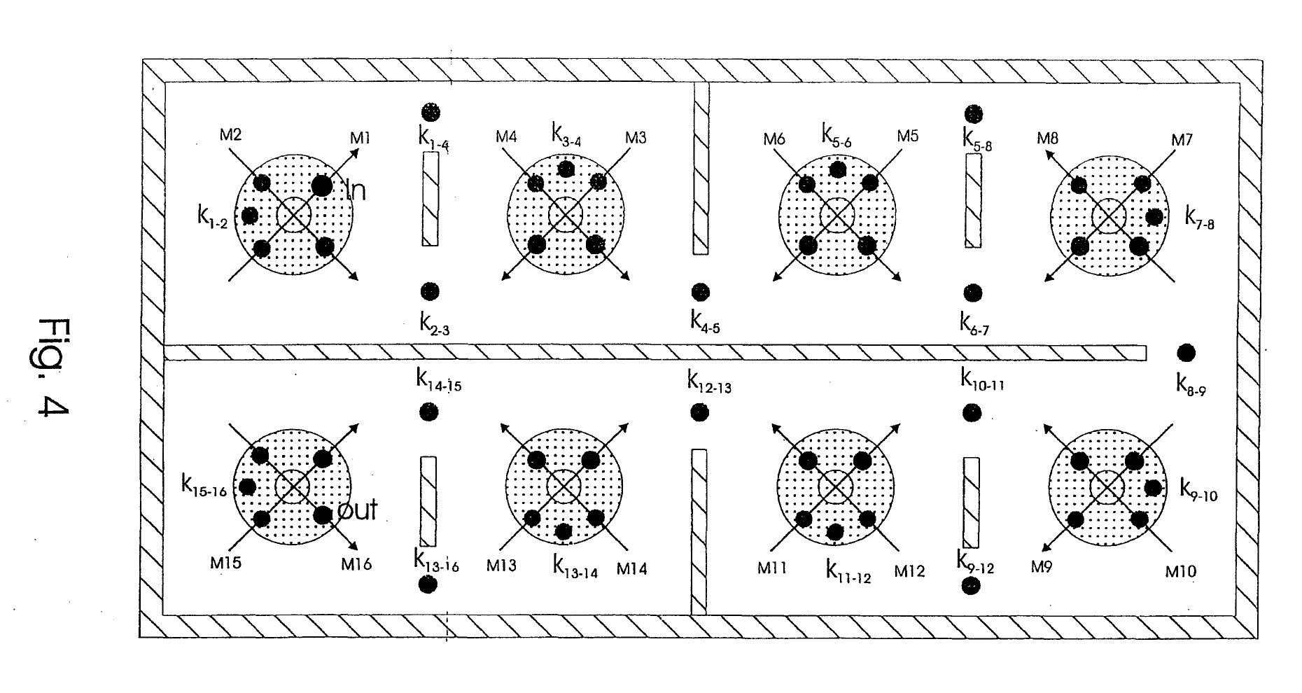

FIG. 4 a schematic top view onto a sixteen-polar cascade quadruplet filter having eight dielectric dual mode resonators.

FIG. 2 shows a schematic top view onto an eight-polar cascade quadruplet filter or multi-polar bandpass filter according to the present invention. Metal walls 2 are arranged in a metal housing 1. The metal walls 2 divide the chamber surrounded by the metal housing into more or less defined areas. A dielectric dual mode resonator 3 is placed in each of these areas. On the whole, therefore, there are four dual mode resonators 3 in the metal housing 1 in the present embodiment. The metal housing 1 also has a base plate 1.1, each dual mode resonator 3 being kept at a distance from it by a spacer 4. The metal walls 2 form coupling gaps 2.1 and 2.2 between the individual dual mode resonators 3. The dual mode resonators 3 are arranged behind one another or beside one another in a predetermined sequence or cascade. Two dual mode resonators 3 each that follow one another in the cascade form a quadruplet. In FIG. 2, the dual mode resonators 3 with the mode numbers 1 to 4 (M1, M2, M3, M4) form a first quadruplet and the dual mode resonators with the mode numbers 5 to 8 (M5, M6, M7, M8) form a further, second quadruplet.

The first dual mode resonator 3 in each of a predetermined series or cascade of dual mode resonators, i.e. the dual mode resonator with the mode number 1 (M1), is coupled to this mode M1 with an input antenna 5a. The respectively last dual mode resonator 3 in the cascade, i.e. the dual mode resonator with the mode number 8 (M8) is coupled to this mode M8 with an output antenna 5b. Each dual mode resonator 3 comprises a dual mode coupler 6 and a dual mode tuner 7. The dual mode coupler 6 and the dual mode tuner 7 are inserted from the base plate 1.1 side.

Control elements 8, with the aid of which the coupling power can be set between the resonators 3, are arranged in the coupling gaps 2.1. The metal walls 2 serve to limit the couplings between the resonators 3. In this way, the metal walls 2 between two dual mode resonators 3 of a quadruplet following one another in the predetermined series or cascade form two coupling gaps 2.1. The metal walls between two dual mode resonators 3 of different quadruplets following one another in the predetermined series form a single coupling gap 2.2.

Two embodiments are shown in FIG. 3 and in FIG. 4 which have the same coupling principle of the embodiment described in FIG. 2: they only differ therein that six dual mode resonators 3 are coupled to one another in FIG. 3 and even eight dual mode resonators 3 in FIG. 4. The connection of the output antenna 5b is made at the last mode 12 M12 in the embodiment shown in FIG. 3 and at the last mode 16 M16 in the embodiment shown in FIG. 4.

A typical characteristic curve for a twelve-polar cascade quadruplet filter is shown in FIG. 1, said filter being formed from three cascade quadruplets. Three finite zero lines of transmission each are present on both sides of the bandpass.

1. Multi-polar bandpass filter based on a group of dielectric dual mode resonators which are arranged in a metal housing and coupled to one another, characterized therein that metal walls (2) in the metal housing (1) produce the coupling between the dual mode resonators (3) in such a way that, on the one hand, a positive forward coupling takes place between respectively adjacent resonator pairs and, on the other hand, a positive and a negative coupling takes place within each resonator pair consisting of dual mode resonators (3).

2. Multi-polar bandpass filter according to claim 1, based on a group of dielectric dual mode resonators which are arranged in a metal housing and coupled to one another, characterized therein that the coupling between several dual mode resonators (3) attain the same filtering quality as a single non-coupled dual mode resonator (3).

3. Multi-polar bandpass filter according to claim 1, characterized therein that the group of dual mode resonators have an even number of dual mode resonators (3), two dual mode resonators (3) each following one another in the predetermined series forming a quadruplet.

4. Multi-polar bandpass filter according to claim 2, characterized therein that each metal wall (2) between two dual mode resonators (3) of a quadruplet forms two coupling gaps (2.1).

5. Multi-polar bandpass filter according to claim 2 or claim 3, characterized therein that each metal wall (2) between two dual mode resonators (3) of different quadruplets following one another in the cascade forms a coupling gap (2.2).

6. Multi-polar bandpass filter according to any of claims 2 to 4, characterized therein that a control element (8) for setting a coupling power is situated in each coupling gap (2.1, 2.2).

7. Multi-polar bandpass filter according to any of the preceding claims, characterized therein that an input antenna (5a) is coupled with a first mode (M1) of a first dual mode resonator (3) in the cascade and an output antenna (5b) is coupled with a last mode (M8, M12, M16) of a last dual mode resonator in the cascade.

8. Multi-polar bandpass filter according to any of the preceding claims, characterized therein that the metal housing (1) has a base plate (1.1), each dual mode resonator (3) of the predetermined series being kept at a distance from it by a spacer (4).

9. Multi-polar bandpass filter according to any of the preceding claims, characterized therein that two, three or four quadruplets are coupled to one another.
